(19) United States
(12) Patent Application Publication
(10) Pub. No.: US 2023/0247568 A1
(43) Pub. Date: Aug. 3, 2023

(54) METHODS FOR COMMUNICATION UNDER MULTIPLE LINKS AND ELECTRONIC DEVICE

(71) Applicant: BEIJING XIAOMI MOBILE SOFTWARE CO., LTD., Beijing (CN)

(72) Inventor: Xiandong DONG, Beijing (CN)

(21) Appl. No.: 18/013,118

(22) PCT Filed: Jul. 24, 2020
(86) PCT No.: PCT/CN2020/104498

§ 371 Date: Dec. 27, 2022

(51) Int. Cl. H04W 52/58; H04W 52/16

(52) U.S. Cl. CPC H04W 52/58; H04W 52/16

(57) ABSTRACT

A method for communication on multiple links is performed by a terminal control device. The method comprises: generating a first message frame; and broadcasting the first message frame on a first link, the first message frame comprising information related to transmission power corresponding to the multiple links.

### CROSS-REFERENCE TO RELATED APPLICATION

This application is the U.S. national phase application of International Application No. PCT/CN2020/104498, filed on Jul. 24, 2020, the entire disclosure of which is incorporated herein by reference.

### TECHNICAL FIELD

The disclosure relates to the field of communication technologies, and provides a method for communication on multiple links and an apparatus for communication on multiple links.

### BACKGROUND

In May, 2018, Institute of Electrical and Electronic Engineers (IEEE) established a Study Group (SG) IEEE802.11be to study the next generation of Wi-Fi technology (i.e., IEEE802.11a/b/g/n/ac). The studied scope includes 320 MHz bandwidth transmission, and aggregation and cooperation of multiple frequency bands. It is expected to increase the rate and throughput by at least four times relative to the existing IEEE802.11ax standard, and main application scenarios are video transmission, Augmented Reality (AR), and Virtual Reality (VR), etc.

The aggregation and cooperation of multiple frequency bands refers to performing simultaneous communications between devices in 2.4 GHz, 5.8 GHz and 6-7 GHz frequency bands at the same time, and a new Media Access Control (MAC) mechanism needs to be defined to manage the simultaneous communications in the multiple frequency bands. In addition, a low latency transmission is expected to be supported in the IEEE802.11be standard.

In the IEEE802.11be standard, the maximum bandwidth supported is 320 MHz (160 MHz+160 MHz). The IEEE802.11be standard may also support 240 MHz (160 MHz+80 MHz) and bandwidths supported in the IEEE802.11ax standard.

### SUMMARY

According to a first aspect of the disclosure, a method for communication on multiple links is performed by a terminal control device. The method includes: generating a first message frame; and broadcasting the first message frame on a first link, in which the first message frame includes information related to transmission powers corresponding to the multiple links.

According to a second aspect of the disclosure, a method for communication on multiple links is performed by a station. The method includes: receiving a first message frame on a first link, in which the first message frame includes information related to transmission powers corresponding to the multiple links.

According to a third aspect of the disclosure, an electronic device is provided. The electronic device includes: a processor and a memory configured to store computer programs executable by the processor. When the computer programs are executed by the processor, the processor is configured to generate a first message frame; and broadcast the first message frame on a first link, in which the first message frame comprises information related to transmission powers corresponding to the multiple links.

### BRIEF DESCRIPTION OF THE DRAWINGS

The above and additional features of embodiments of the disclosure will become more apparent by describing the embodiments of the disclosure in detail with reference to the accompanying drawings.

FIG. 1 is a schematic diagram of an example of multiple links between an AP and an STA.

FIG. 2 is a flowchart of a method for communication on multiple links according to an embodiment of the disclosure.

FIG. 3 is a flowchart of method for communication on multiple links according to another embodiment of the disclosure.

FIG. 4 is a schematic diagram of a communication scenario on multiple links according to an embodiment of the disclosure.

FIG. 5 is a schematic diagram of an apparatus for communication on multiple links according to an embodiment of the disclosure.

FIG. 6 is a schematic diagram of an apparatus for communication on multiple links according to another embodiment of the disclosure.

### DETAILED DESCRIPTION

The following description with reference to the accompanying drawings is provided to fully understand the various embodiments of the disclosure as defined by the appended claims and their equivalents. The various embodiments of the disclosure include various specific details, but such specific details are considered to be exemplary only. In addition, descriptions of well-known techniques, functions and constructions may be omitted for the sake of clarity and conciseness.

The terms and words used in this disclosure are not limited to their written meaning, but are used only by the inventors to clearly and consistently understand the disclosure. Accordingly, for those skilled in the art, the description of the various embodiments of the disclosure is provided for illustrative purposes only, and is not intended to limit the disclosure.

It should be understood that, unless the context clearly indicates otherwise, the singular forms “a/an”, “one”, “said” and “the” used herein may also include plural forms. It should be further understood that the term “includes” as used in this disclosure refers to the presence of the described features, integers, steps, operations, elements and/or components, but does not exclude the presence or addition of one or more other features, integers, steps, operations, elements, components and/or their combination.

It is understood that while the terms “first” and “second” may be used herein to describe various elements, these elements should not be limited by these terms. These terms are used only to distinguish one element from another. Therefore, without departing from the teachings of the embodiments, the first element discussed below may be referred to as the second element.

It should be understood that when the element is “connected” or “coupled” to another element, it may be directly connected or coupled to other elements, or there may be an intermediate element. In addition, “connected” or “coupled” as used herein may include wirelessly connected or wirelessly coupled. The term “and/or” or the expression “at least one/at least one of” as used herein includes any and all combinations of one or more relevant listed items.

The embodiments of the disclosure will be described in detail below in combination with the accompanying drawings.

In the IEEE802.11be standard, a Station (STA) and an Access Point (AP) may be Multi-Link Devices (MLDs) that support the function of simultaneously transmitting and/or receiving on multiple links. Therefore, in the IEEE802.11be standard, there can be multiple links between the STA and the AP. In the IEEE802.11be standard, an initial association is established between the STA supporting multiple links and the AP supporting multiple links through one link, and multiple links need to be established when data communication is required. The frequency band of each link between the STA and the AP may be different, so its coverage area is also different, and the transmission power required to establish each link is also different. However, in the existing standards, only a transmission power on the current link is specified, which is not applicable to multi-link communication environments on multiple links.

In a wireless Local Area Network (LAN), a Basic Service Set (BSS) may be consisted of an AP and one or more STAs that communicate with the AP. The BSS may be connected to a Distribution System (DS) through its AP and then connected to another BSS to generate an Extended Service Set (ESS).

The AP may include software applications and/or circuitries to allow other types of nodes in the wireless LAN to perform communications with the outside and the inside of the wireless LAN via the AP. The AP may communicate with the STA on different time-frequency resources. For example, the AP may be a terminal device or a network device equipped with a Wireless Fidelity (Wi-Fi) chip. As an example, the STA may include, but is not limited to: a cellular phone, a smart phone, a wearable device, a computer, a Personal Digital Assistant (PDA), a Personal Communication System (PCS) device, a Personal Information Manager (PIM), a Personal Navigation Device (PND), a global positioning system, a multimedia device, and an Internet of Things (IoT) device.

In the embodiments of the disclosure, the STA and the AP may support the function of multiple links. For ease of description, in the following text, an example of a communication scenario between an AP and an STA on multiple links is primarily described. However, the embodiments of the disclosure are not all described in the disclosure.

If the STA needs to join a BSS, it needs to establish an association link or a re-association link with an AP in the BSS. Generally, the AP can broadcast a beacon frame, the STA sends an association request frame or a re-association request frame to the AP after receiving the beacon frame, and the AP returns a response frame for the association request frame or the re-association request frame sent by the STA. An initial association link or a re-association link between the AP and the STA is established when the STA receives the returned response frame indicating that the link is successful.

In the existing standards, the AP broadcasts a beacon frame carrying transmission power constraint elements, as shown in Table 1 below. The STA carries power capability elements supported in the association request frame or re-association request frame, as shown in Table 2 below.

TABLE 1
Power Constraint Element

| Element ID | Length | Local Power Constraint |
|---|---|---|
| (Octets): 1 | 1 | 1 |

TABLE 2
Power Capability Element

| Element ID | Length | Local Power Constraint |
|---|---|---|
| (Octets): 1 | 1 | 1 |

When there are multiple links between the AP and the STA, the following situation may occur. When the STA needs to establish the initial association link or the re-association link with the AP as a MLD, the STA can monitor the beacon frame from the AP on one link, but since the BSS load on the link where the beacon frame is monitored exceeds a threshold value, the initial association link or the re-association link needs to be established on another link. The multiple links can be multiple links at different frequencies, e.g., at 2.4 GHz, 5 GHz, and 6 GHz. In the existing standards, the beacon frame broadcasted by the AP carries only the transmission power or transmission power constraint of the beacon frame on the current link, and the transmission power or the transmission power constraint on other links are not specified. However, when there are multiple links between the AP and the STA, since the coverage range is different on each link (in particular, the frequency band on each link is different), if a single transmission power is used to send a message frame on each link, the message frame may not reach a receiver, as shown in FIG. 1.

In FIG. 1, the AP-MLD may represent an AP that supports a multi-link communication function, and the Non-AP-MLD may represent an STA that supports the multi-link communication function. Three links (2.4 GHz, 5 GHz, and 6 GHz) between the AP-MLD and the Non-AP-MLD are shown in FIG. 1, which are only exemplary and are not limited in the embodiments of the disclosure. It is understood that the multiple links between the STA and the AP may represent multiple channels between the STA and the AP that are in different frequency bands. As shown in FIG. 1, assuming that the same transmission power is used on the three links, the AP-MLD is reachable to the Non-AP-MLD only on the 2.4 GHz link, while the AP-MLD is not reachable to the Non-AP-MLD on the 5 GHz/6 GHz link.

As mentioned above, since in the existing standards, the beacon frame broadcasted by the AP carries only the transmission power of the beacon frame on the current link and does not includes transmission power information on other links, which cannot be adaptive to the communication environments on multiple links. The solution according to the embodiments of the disclosure can define the transmission power on each link, so that the STA can more directly determine the transmission powers on different links (transmission power of the association request frame or the re-association request frame).

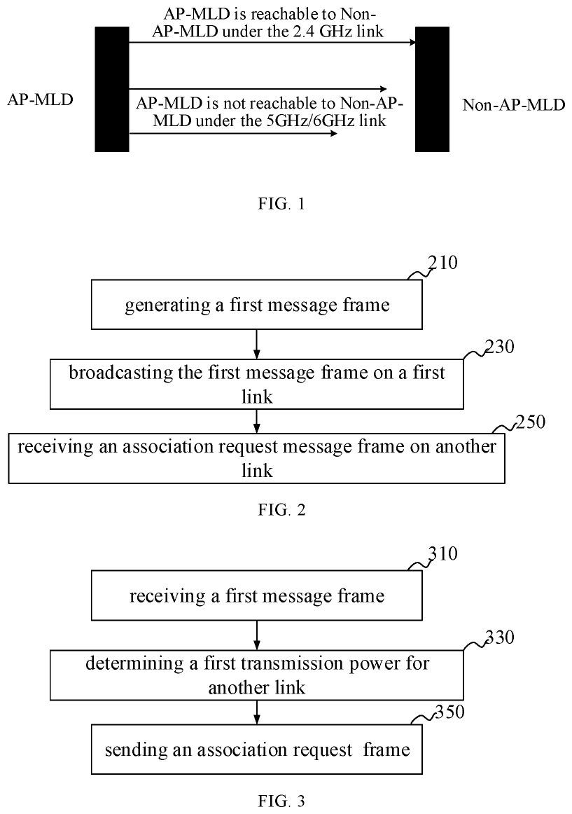

FIG. 2 is a flowchart of a method for communication on multiple links according to an embodiment of the disclosure. The method of FIG. 2 may be executed by a terminal control device. In the embodiments of the disclosure, the terminal control device may include, but is not limited to, an AP or any type of controller.

As shown in FIG. 2, at step 210, the first message frame may be generated. According to the embodiments of the disclosure, the first message frame may be a beacon frame broadcasted by the AP, which is not limited in the embodiments of the disclosure. The first message frame may be any other type of frame depending on the communication environments. In an embodiment, the first message frame may be generated based on the communication capability of the AP and the current communication environment. In another embodiment, a pre-stored or pre-written first message frame may be obtained directly, and the step 210 of generating the first message frame may be thus omitted.

At step 230, the first message frame is broadcasted on a first link. According to the embodiments of the disclosure, the first message frame may include information related to the transmission powers corresponding to the multiple links. That is, the first message frame may include not only transmission power information on the first link for broadcasting the first message frame, but may also include transmission power information for other links other than the first link.

According to the embodiments of the disclosure, the information related to the transmission powers corresponding to the multiple links may include at least local power constraint identities (IDs) on the multiple links. In addition, the information related to the transmission powers corresponding to the multiple links may also include: link IDs for identifying the multiple links. That is, the power constraint elements present in the beacon frame may be directly used, and the power constraint elements may include a local power constraint ID related to each link in the multiple links and a link ID corresponding to each link, as shown in Table 3 below.

TABLE 3
Power Constraint Element

| | | | | | | |
|---|---|---|---|---|---|---|
| Element | Length | Local Power | Link 1 | Local Power | Link 2 | . . . |
| ID | | Constraint 1 | | Constraint 2/ | | |
| | | | | difference | | |
| | | | | compared to | | |
| | | | | Link 1 | | |

In Table 3, Local Power Constraint 1, and Local Power Constraint 2/difference compared to Link 1, etc. may correspond to the local power constraint IDs on the multiple links, and Link 1 and Link 2, etc. may correspond to the link IDs.

It is understood that the local power constraint ID may indicate a local-allowed (maximum) transmission power on each link. For example, the local power constraint IDs on the multiple links may be either absolute values or relative values. The absolute value may represent a transmission power value on a corresponding link, and the relative value may represent an offset of the transmission power on the corresponding link with respect to a reference value. For example, in Table 3, Local Power Constraint 1, and Local Power Constraint 2, etc., may represent absolute values, i.e., may represent the local allowed (maximum) transmission powers on Link 1 and Link 2, respectively. When the transmission power on Link 1 is used as the reference value (alternatively, the transmission power on the first link for sending/broadcasting the first message frame can be used as the reference value), difference compared to Link 1 may represent an offset of the transmission power of Link 2, i.e., a difference between the transmission power of Link 2 and the transmission power of Link 1, so that the transmission power of Link 2 can be obtained based on the reference value (e.g., Local Power Constraint 1) and difference compared to Link 1. However, what is shown in Table 3 is only exemplary and is not limited in the embodiments of the disclosure. For example, a particular other transmission power value may be pre-set as the reference value, and then the local power constraint IDs on the multiple links are expressed in the form of relative values.

In addition, the link IDs can also be absolute values or relative values. The absolute value may indicate a link ID number of each link, and the relative value may indicate an offset of the link ID number of each link with respect to the reference value. In addition, the link IDs may also be omitted. That is, the first message frame may include only an information group of the local power constraint IDs, and locations of the local power constraint IDs in the information group implicitly correspond to the link IDs. For example, referring to Table 3, only Local Power Constraint 1, and Local Power Constraint 2/difference compared to Link 1, etc., may be included, and their locations also implicitly correspond to the link IDs. For example, the multiple links may be ordered according to the size of each frequency band in which each link is located, and then only the local power constraint ID corresponding to each link is shown in the power constraint elements sequentially. In this case, the link IDs may be excluded and the sequence of the local power constraint IDs in Table 3 corresponds to the sequence of the multiple links respectively.

According to another embodiment of the disclosure, the information related to the transmission powers corresponding to the multiple links may include at least maximum transmission power IDs on the multiple links. That is, a maximum transmission power element may be redefined to indicate maximum transmission power information related to each link in the multiple links, as shown in Table 4 below.

TABLE 4
Maximum Transmission Power Element

| | | | | | | |
|---|---|---|---|---|---|---|
| Element | Length | Maximum | Link 1 | Maximum | Link 2 | . . . |
| ID | | transmission | | transmission | | |
| | | power 1 | | power 2/ | | |
| | | | | difference | | |
| | | | | compared to | | |
| | | | | Link 1 | | |

In Table 4, Maximum transmission power 1, and Maximum transmission power 2/difference compared to Link 1 may correspond to the maximum transmission power IDs, and Link 1 and Link 2, etc., may correspond to the link IDs.

It is understood that the maximum transmission power ID may indicate the maximum transmission power on each link. That is, the maximum transmission power ID may define a transmission power value that is not allowed to be exceeded on each link. For example, the maximum transmission power IDs on the multiple links may be absolute values or relative values, and the link IDs may also be absolute values or relative values. The absolute value or the relative value have the same meaning as described above with reference to Table 3, and the repetitive description is omitted herein for conciseness. Optionally, the first message frame may include only an information group of the maximum transmission power IDs, and the locations of the maximum transmission power IDs in the information group implicitly correspond to the link IDs, similar to the information group of the local power constraint IDs described above, which is omitted herein for conciseness.

The power constraint element of Table 3 and/or the maximum transmission power element of Table 4 may be encapsulated in the first message frame (e.g., the beacon frame) for transmission.

As shown in FIG. 2, at step 250, the association request frame may be received on another link. In detail, an association request message frame sent by a device that has received the first message frame is received on another link other than the first link at step 230. According to the embodiments, the association request message frame may include an association request frame or a re-association request frame. According to the embodiments, the association request message frame is sent at a first transmission power on the another link by the device that has received the first message frame, and the first transmission power is a transmission power on the another link determined by the device based on the information related to the transmission powers corresponding to the multiple links. It is understood that in the method of FIG. 2, step 250 may be omitted. That is, when a channel environment of the first link used to transmit the first message frame is allowed (e.g., the BSS load does not exceed the threshold value), the association request frame or the re-association request frame may be received directly on the first link.

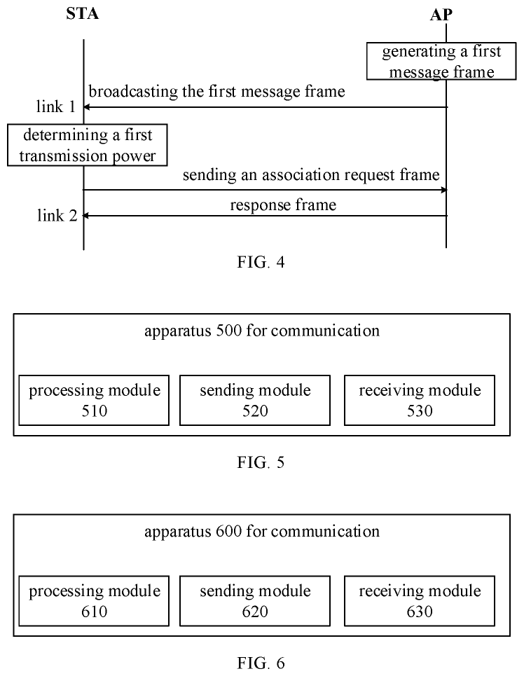

The device that has received the first message frame (i.e., the STA) can determine the first transmission power on another link based on the information in such as Table 3 or Table 4 included in the first message frame, which is described in detail below with reference to FIGS. 3 and 4.

As shown in FIG. 3, at step 310, a first message frame may be received on a first link (e.g., Link 1 in FIG. 4). The first message frame may include information related to the transmission powers corresponding to the multiple links. The information related to the transmission powers corresponding to the multiple links includes at least local power constraint IDs on the multiple links or maximum transmission power IDs on the multiple links. The information related to the transmission powers corresponding to the multiple links may also include the link IDs for identifying the multiple links. The local power constraint IDs on the multiple links, the maximum transmission power IDs on the multiple links, and the link IDs are the same with those in step 210, Table 3, and Table 4, the repeated descriptions of which are omitted herein for brevity.

At step 330, a first transmission power for another link other than the first link may be determined. It is understood that step 330 may be omitted when the BSS load on the first link does not exceed the threshold value, i.e., the association request frame may be sent directly on the first link at step 350.

According to the embodiments, when the STA receives the first message frame (e.g., the beacon frame), the STA may determine the first transmission power for another link (e.g., Link 2 in FIG. 4) other than the first link based on the information related to transmission powers corresponding to the multiple links in the first message frame. For example, after receiving the beacon frame broadcasted by the AP, the STA calculates a received signal strength indication (RSSI) of the beacon frame, calculates a path loss based on the RSSI of the beacon frame, and determines a transmission power for sending the association request frame or the re-association request frame based on the calculated path loss and information related to a transmission power for the link used to send the association request frame (e.g., the local power constraint IDs or maximum transmission power IDs), which is only exemplary. The transmission power for sending the association request frame may be determined in various ways based on the information related to transmission powers corresponding to the multiple links in the first message frame, which is not limited in the embodiments of the disclosure.

At step 350, on another link (e.g., Link 2 of FIG. 4), an association request message frame is sent at the calculated first transmission power. According to the embodiments, the association request message frame may include the association request frame or the re-association request frame.

As shown in FIG. 4, when the STA receives a response frame related to the association request frame or the re-association request frame, and the response frame indicates that the link is successful, establishment of the initial association link or the re-association link between the STA and the AP is completed. The response frame may be transmitted on Link 2, which is not limited in the embodiments of the disclosure. For example, the response frame may be transmitted on other link in the multiple links depending on the communication environments.

The communication method according to the embodiments of the disclosure is capable of establishing the initial association link or the re-association link with the AP on another link, adapting to the communication environments on multiple links, thus improving the throughput of the network.

FIG. 5 is a schematic diagram of an apparatus 500 for communication on multiple links according to an embodiment of the disclosure.

As shown in FIG. 5, the apparatus 500 for communication includes: a processing module 510, a sending module 520 and a receiving module 530.

The processing module 510 may be configured to generate a first message frame.

The sending module 520 may be configured to broadcast the first message frame on a first link, in which the first message frame includes information related to transmission powers corresponding to the multiple links.

According to an embodiment of the disclosure, the information related to the transmission powers corresponding to the multiple links includes at least local power constraint IDs on the multiple links.

According to an embodiment of the disclosure, the information related to the transmission powers corresponding to the multiple links includes at least maximum transmission power IDs on the multiple links.

According to an embodiment of the disclosure, the information related to the transmission powers corresponding to the multiple links further includes link IDs for identifying the multiple links.

The receiving module 530 may be configured to receive an association request message frame sent from a device that has received the first message frame (e.g., an apparatus 600 for communication of FIG. 6) on another link other than the first link.

According to the embodiment of the disclosure, the association request message frame is sent at the first transmission power by the device that has received the first message frame on another link. The first transmission power is a transmission power on the another link determined by the device based on the information related to the transmission powers corresponding to the multiple links.

FIG. 6 is a schematic diagram of an apparatus 600 for communication on multiple links according to an embodiment of the disclosure.

As shown in FIG. 6, the apparatus 600 for communication includes: a processing module 610, a sending module 620 and a receiving module 630.

The receiving module 630 may be configured to receive, on a first link, (e.g., from the apparatus 500 for communication) a first message frame, in which the first message frame includes information related to transmission powers corresponding to the multiple links.

According to an embodiment of the disclosure, the information related to the transmission powers corresponding to the multiple links includes at least local power constraint IDs on the multiple links.

According to an embodiment of the disclosure, the information related to the transmission powers corresponding to the multiple links includes at least maximum transmission power IDs on the multiple links.

According to an embodiment of the disclosure, the information related to the transmission powers corresponding to the multiple links further includes link IDs for identifying the multiple links.

The processing module 610 may be configured to determine a first transmission power for another link other than the first link based on the information related to the transmission powers corresponding to the multiple links received by the receiving module 630.

The sending module 620 may be configured to send an association request message frame at the first transmission power on the another link.

The configurations of the apparatus 500 for communication of FIG. 5 and the apparatus 600 for communication of FIG. 6 are exemplary only and are not limited in the embodiments of the disclosure. For example, the apparatus 500 for communication and the apparatus 600 for communication of FIG. 6 may include more modules or fewer modules.

The apparatus for communication in the embodiments of the disclosure is capable of establishing an initial association link or a re-association link with an AP on another link, adapting to communication environments on multiple links, and thus improving the throughput of the network.

In addition, the modules described above may be implemented by a combination of software and/or hardware, which is not limited in the embodiments of the disclosure.

Based on the same principles as the method according to embodiments of the disclosure, the embodiments of the disclosure also provide an electronic device. The electronic device includes: a processor and a memory for storing machine-readable instructions (which may also be referred to as computer programs). The processor is configured to execute the machine-readable instructions to implement the methods described with reference to FIG. 2 to FIG. 4.

The embodiments of the disclosure also provide a computer-readable storage medium having computer programs stored. When the computer programs are executed by a processor, the methods described with reference to FIG. 2 to FIG. 4 are implemented.

In the embodiments, the processor may be a logic block, a module or a circuit for implementing or executing various exemplary embodiments described in the disclosure, for example, a Central Processing Unit (CPU), a general processor, a Digital Signal Processor (DSP), an Application Specific Integrated Circuit (ASIC), a Field Programmable Gate Array (FPGA), or other programmable logic devices, transistor logic devices, hardware components or any their combination. The processor may also be a combination used to implement a computing function, for example, a combination consisting of one or more microprocessors, and a combination consisting of DSPs and microprocessors, etc.

In the embodiments, the memory may be, for example, a Read Only Memory (ROM), a Random Access Memory (RAM), an Electrically Erasable Programmable Read Only Memory (EEPROM), a Compact Disc Read Only Memory (CD-ROM) or other optical disc memories, optical disk memories (including compact disc, laser disc, CD-ROM, digital general disc, and Blu-ray disc), disk storage mediums or other magnetic storage devices, or any other medium that can be used to carry or store program codes in the form of instructions or data structures and can be accessed by a computer, which is not limited herein.

The technical solutions according to the embodiments of the disclosure may adapt to communication environments on multiple links, thus improving the throughput of a network.

It should be understood that although steps in the flowchart of the accompanying drawings are shown sequentially as indicated by the arrows, the steps are not necessarily performed sequentially in the order indicated by the arrows. Unless explicitly stated otherwise in the disclosure, there is no strict sequential limitation on the execution of these steps, which may be performed in any other order. In addition, at least some of the steps in the flowchart of the accompanying drawings may include a plurality of sub-steps or a plurality of phases, which are not necessarily executed at the same time, but may be executed at different times. The execution order is not necessarily sequential, and the steps can be performed alternately or alternatively with other steps or at least part of sub-steps or phases of other steps.

Although the disclosure has been shown and described with reference to the embodiments of the disclosure, it will be understood by those skilled in the art that various changes in form and detail can be made without departing from the scope of the disclosure. Accordingly, the scope of the disclosure should not be limited by the embodiments, but should be defined by the appended claims and their equivalents.

1. A method for communication on multiple links, performed by a terminal control device, comprising:
generating a first message frame; and
broadcasting the first message frame on a first link, wherein the first message frame comprises information related to transmission powers corresponding to the multiple links.

2. The method of claim 1, wherein the information related to the transmission powers corresponding to the multiple links comprises at least local power constraint identities on the multiple links.

3. The method of claim 1, wherein the information related to the transmission powers corresponding to the multiple links comprises at least maximum transmission power identities on the multiple links.

4. The method of claim 2, wherein the information related to the transmission powers corresponding to the multiple links further comprises link identities for identifying the multiple links.

5. The method of claim 1, further comprising:
receiving, on another link other than the first link, an association request message frame sent by a device that has received the first message frame;
wherein the association request message frame is sent at a first transmission power by the device on the another link; and
wherein the first transmission power is a transmission power on the another link determined by the device based on the information related to the transmission powers corresponding to the multiple links.

6. A method for communication on multiple links, performed by a station, comprising:
receiving a first message frame on a first link, wherein the first message frame comprises information related to transmission powers corresponding to the multiple links.

7. The method of claim 6, wherein the information related to the transmission powers corresponding to the multiple links comprises at least local power constraint identities on the multiple links.

8. The method of claim 6, wherein the information related to the transmission powers corresponding to the multiple links comprises at least maximum transmission power identities on the multiple links.

9. The method of claim 7, wherein the information related to the transmission powers corresponding to the multiple links further comprises link identities for identifying the multiple links.

10. The method of claim 1, further comprising:
determining a first transmission power for another link other than the first link based on the information related to the transmission powers corresponding to the multiple links; and
sending an association request message frame at the first transmission power on the another link.

11-12. (canceled)

13. An electronic device comprising:
a processor and
a memory, configured to store computer programs executable by the processor,
wherein when the computer programs are executed by the processor, the processor is configured to:
generate a first message frame; and
broadcast the first message frame on a first link of multiple links, wherein the first message frame comprises information related to transmission powers corresponding to the multiple links.

14. A non-transitory computer readable storage medium having computer programs stored thereon, wherein when the computer programs are executed by a processor, the method of claim 1 is implemented.

15. The method of claim 3, wherein the information related to the transmission powers corresponding to the multiple links further comprises link identities for identifying the multiple links.

16. The method of claim 8, wherein the information related to the transmission powers corresponding to the multiple links further comprises link identities for identifying the multiple links.

17. The electronic device of claim 13, wherein the information related to the transmission powers corresponding to the multiple links comprises at least local power constraint identities on the multiple links.

18. The electronic device of claim 13, wherein the information related to the transmission powers corresponding to the multiple links comprises at least maximum transmission power identities on the multiple links.

19. The electronic device of claim 17, wherein the information related to the transmission powers corresponding to the multiple links further comprises link identities for identifying the multiple links.

20. The electronic device of claim 18, wherein the information related to the transmission powers corresponding to the multiple links further comprises link identities for identifying the multiple links.

21. The electronic device of claim 13, wherein the processor is further configured to:
receive, on another link other than the first link, an association request message frame sent by a device that has received the first message frame;
wherein the association request message frame is sent at a first transmission power by the device on the another link; and
wherein the first transmission power is a transmission power on the another link determined by the device based on the information related to the transmission powers corresponding to the multiple links.
